(19) United States
(12) Patent Application Publication
(10) Pub. No.: US 2026/0359770 A1
(43) Pub. Date: Nov. 12, 2026

(54) Device for estimating a physical magnitude with two models and associated system and method

(71) Applicant: THALES, Meudon (FR)

(72) Inventors: Fateh KAAKAI, PALAISEAU CEDEX (FR); Jean-Marc GUAUS, TOULOUSE CEDEX 1 (FR); Geoffrey DELHOMME, MERIGNAC (FR)

(21) Appl. No.: 19/674,126

(22) Filed: May 12, 2026

(30) Foreign Application Priority Data
May 12, 2025 (FR) 25 05004

(51) Int. Cl. G06Q 10/083

(52) U.S. Cl. CPC G06Q 10/083

(57) ABSTRACT

An estimation device for a physical magnitude including a first estimation module including a first computing unit suitable for applying a first model to data acquired by an acquisition device in order to obtain a first prediction of the physical magnitude, a second estimation module including a second computing unit suitable for applying a second model to the acquired data in order to obtain a second prediction of the physical magnitude, the second model being an update of the first model, and an analysis module suitable for analyzing the consistency of values resulting from the first prediction and the second prediction and for deducing, from the consistency analysis, an estimate of the physical magnitude to be estimated for the estimation device.

### REFERENCE TO RELATED APPLICATIONS

This application is a U.S. non-provisional application claiming the benefit of French Patent Application No. 25 05004 filed on May 12, 2025, the contents of which are incorporated herein by reference in their entirety.

### TECHNICAL FIELD OF THE INVENTION

The present invention relates to a device for estimating a physical magnitude. It also relates to an estimation system including such an estimation device as well as to an associated estimation method.

### BACKGROUND OF THE INVENTION

Artificial intelligence technologies are increasingly used to develop models resulting from data-driven machine learning in critical systems.

These models are in particular estimation models suitable for providing an estimated value of the physical magnitude over a predefined domain of use.

The predefined domain of use is, by definition, the set of operating conditions wherein the estimation model is specifically designed to operate, including, but not limited to, environmental, geographical, and temporal restrictions.

The predefined domain of use is often referred to by the abbreviation ODD, which refers to the English term “operational design domain”.

The estimation model is thus trained on data reflecting the domain of use, assuming that the data processed by the estimation model in operation will always be part of the domain of use.

However, it frequently happens that the situations (i.e., the data) encountered in practice by the estimation model are different from those used to train them.

This leads the estimation model to face changes over time in the data distribution (more commonly referred to by the term “data drift”), changes in the relationship between the inputs and output(s) of the estimation model (more commonly referred to by the term “concept drift”), or even data that are not included in the predefined domain of use (abnormal data or “outliers” by reference to the corresponding term).

The performance of the estimation model is impacted, which is addressed by performing frequent updates of the estimation model, for example, every quarter, every month, every week, every day, or after each operational mission using the estimation model. These updates must be performed even when access to data is restricted.

For these updates, it is known to use incremental learning and qualification techniques. This involves retraining on small increments of datasets including a selection of new data and old data. This makes it possible to avoid using a complete dataset that is too large to perform the update of the estimation model.

However, in the context of frequent and rapid updates of an estimation model, it is common that the new version includes problems (more often called bugs) due to the fact that the design, verification, and validation activities of the estimation model are insufficient because of the constraints imposed by development and incremental qualification. Lack of time, an insufficient volume of new training and test data, or lack of access to such data are examples of such constraints.

In particular, catastrophic forgetting problems may occur. This corresponds to a situation wherein the estimation model loses previously acquired knowledge during the incremental update. This is not acceptable for a critical system that requires guaranteeing the safe preservation of certain functionalities.

There is therefore a need for a device for estimating a physical magnitude allowing an estimation model updated incrementally under constraints (reduced time, reduced data volume, reduced access to data) to be operated with increased safety, in particular for use of the estimation device in a critical system.

### SUMMARY OF THE INVENTION

To that end, the description has as its object a device for estimating a physical magnitude, the estimation device including:
a first estimation module, the first estimation module including:
a first receiving unit suitable for receiving data acquired by a detection device, and
a first computing unit suitable for applying a first estimation model to the data received by the first receiving unit in order to obtain a first prediction of the physical magnitude to be estimated,
a second estimation module, the second estimation module including:
a second receiving unit suitable for receiving data acquired by a detection device, and
a second computing unit suitable for applying a second estimation model to the data received by the second receiving unit in order to obtain a second prediction of the physical magnitude to be estimated, the second estimation model being an update of the first estimation model, and
an analysis module, the analysis module being suitable for analyzing the consistency of values resulting from the first prediction and the second prediction and for deducing, from the consistency analysis, an estimate of the physical magnitude to be estimated for the estimation device.

According to other advantageous aspects, the estimation device includes one or more of the following features, taken alone or in any technically possible combinations:
the value resulting from the first prediction and the value resulting from the second prediction are inconsistent, and the analysis module is suitable for deducing that the value of the estimate of the physical magnitude is the value resulting from the first prediction;
the value resulting from the first prediction and the value resulting from the second prediction are consistent, and the analysis module is suitable for deducing that the value of the estimate of the physical magnitude is the value resulting from the second prediction;
the first estimation module includes a first determination unit of a first value representative of confidence in the prediction of the first computing unit, and the second estimation module includes a second determination unit of a second value representative of confidence in the prediction of the second computing unit, the values resulting from the first prediction and the second prediction whose consistency is checked by the analysis module being obtained from the first prediction, the second prediction, the first value representative of confidence in the prediction of the first computing unit, and the second value representative of confidence in the prediction of the second computing unit;
the analysis module further includes:
   a first consolidation unit suitable for obtaining a first consolidated prediction from the first prediction (P_{N}) as a function of a first confidence criterion applied to the first value representative of confidence in the prediction of the first computing unit, and
   a second consolidation unit suitable for obtaining a second consolidated prediction from the second prediction (P_{N}) as a function of a second confidence criterion applied to the second value representative of confidence in the prediction of the second computing unit, the values resulting from the first prediction and the second prediction whose consistency is checked by the analysis module being respectively the first consolidated prediction and the second consolidated prediction;
   the first confidence criterion is a comparison of the first value representative of confidence in the prediction of the first computing unit to a first predefined threshold and the second confidence criterion is a comparison of the second value representative of confidence in the prediction of the second computing unit to a second predefined threshold;
   the estimation device further includes a warning module, the warning module being suitable for issuing an alert in the presence of multiple inconsistencies between the values resulting from the first prediction and the second prediction whose consistency is checked by the analysis module;
   the warning module is suitable for accumulating the results of the consistency analyses and for issuing the alert when the number of inconsistencies, for a number of successive consistency analysis results produced by the analysis module, is greater than or equal to a threshold;
the data acquired by the detection device are images or audio signals;
the physical magnitude characterizes the environment of the detection device, the physical magnitude being in particular the temperature or the presence and/or identification of an object in this environment;
the physical magnitude is a magnitude relating to a means of transport including the detection device, in particular a magnitude giving the trajectory of the means of transport;
the estimation device includes a sending module suitable for sending the estimate of the physical magnitude to be estimated to a control module, the control module being suitable for controlling a physical device as a function of the estimate of the physical magnitude to be estimated, in particular for modifying the operation of the physical device;
the physical device is a means of transport, in particular an aircraft.

The description also has as its subject matter a device for estimating a physical magnitude, the estimation device including:
a first estimation module, the first estimation module including:
a first receiving unit suitable for receiving data acquired by a detection device, and
a first computing unit suitable for applying a first estimation model to the data received by the first receiving unit in order to obtain a first prediction of the physical magnitude to be estimated,
a second estimation module, the second estimation module including:
a second receiving unit suitable for receiving data acquired by a detection device, and
a second computing unit suitable for applying a second estimation model to the data received by the second receiving unit in order to obtain a second prediction of the physical magnitude to be estimated, the second estimation model being a first update of the first estimation model,
a third estimation module, the third estimation module including:
a third receiving unit suitable for receiving data acquired by a detection device, and
a third computing unit suitable for applying a third estimation model to the data received by the third receiving unit (66) in order to obtain a third prediction of the physical magnitude to be estimated, the third estimation model being a second update of the first estimation model,
an analysis module, the analysis module being suitable for receiving each prediction and for obtaining an estimate of the physical magnitude to be estimated for the estimation device from the received predictions, and
an inhibition module, the inhibition module being suitable for inhibiting receipt, by the analysis module, of the prediction of at least one estimation module among the first estimation module, the second estimation module, and the third estimation module.

According to other advantageous aspects, the estimation device includes one or more of the following features, taken alone or in any technically possible combinations:
the inhibition module includes an inhibition unit for each estimation module whose prediction receipt by the analysis module is suitable to be inhibited by the inhibition module;
each inhibition unit includes at least one switch having an open position wherein receipt of the prediction by the analysis module is inhibited and a closed position wherein receipt of the prediction by the analysis module is not inhibited;
the inhibition module is suitable for inhibiting only receipt of the prediction from the second estimation module and the third estimation module;
the inhibition module has a first state wherein only receipt of the prediction from the second estimation module is inhibited and a second state wherein only receipt of the prediction from the third estimation module is inhibited, the estimation device further including a control module, the control module being suitable for controlling the state of the inhibition module;
the control module is suitable for causing implementation of an operation of loading the third estimation model onto the third computing unit and for controlling the inhibition module so that the inhibition module is in the first state when the loading operation has not been implemented and in the second state when the loading operation has taken place;
the analysis module is suitable for analyzing the consistency of values resulting from the received predictions and for deducing, from the consistency analysis, an estimate of the physical magnitude to be estimated for the estimation device;
the predictions received by the analysis module are the first prediction and a prediction among the second prediction and the third prediction;
the data acquired by the detection device are images or audio signals;
the physical magnitude characterizes the environment of the detection device, the physical magnitude being in particular the temperature or the presence and/or identification of an object in this environment;
the physical magnitude is a magnitude relating to a means of transport including the detection device, in particular a magnitude giving the trajectory of the means of transport;
the estimation device includes a sending module suitable for sending the estimate of the physical magnitude to be estimated to a control module, the control module being suitable for controlling a physical device as a function of the estimate of the physical magnitude to be estimated, in particular for modifying the operation of the physical device;
the physical device is a means of transport, in particular an aircraft.

The description also has as its subject matter an estimation system of a physical magnitude, the estimation system including:
several devices for estimating the physical magnitude, each estimation device including an analysis module, each analysis module being suitable for analyzing the consistency of values resulting from predictions obtained by applying at least two estimation models to data acquired by a detection device, one estimation model being an update of another estimation model, in order to obtain a value representative of the consistency between the predictions, and
a coordination system suitable for applying an aggregation function to the values representative of the consistency between the predictions in order to obtain an aggregated value and suitable for deducing an estimate of the physical magnitude to be estimated from the aggregated value.

According to other advantageous aspects, the estimation device includes one or more of the following features, taken alone or in any technically possible combinations:
each physical magnitude estimation device includes a communication system and the coordination system includes a communication unit, the communication unit of the coordination system being suitable for communicating the deduced estimate to each communication system of an estimation device, the estimate of the physical magnitude by each estimation device being the estimate deduced by the coordination system;
the aggregation function is a majority vote;
for each analysis module, the values resulting from each prediction are obtained from the value of the prediction and a value representative of confidence in the prediction;
each estimation device includes, for each prediction, a consolidation unit suitable for obtaining a consolidated prediction from the prediction as a function of a respective confidence criterion applied to the value representative of confidence in the prediction, the values resulting from each prediction whose consistency is checked by the analysis module being respectively the consolidated prediction;
each estimation device further includes a warning module suitable for obtaining a value representative of the temporal evolution of the results of the consistency analysis, the values representative of the consistency between the predictions being the values representative of the temporal evolution;
each estimation device further includes:
a third estimation module, the third estimation module including:
a third receiving unit suitable for receiving data acquired by a detection device, and
a third computing unit suitable for applying a third estimation model to the data received by the third receiving unit in order to obtain a third prediction of the physical magnitude to be estimated, the third estimation model being a second update of the first estimation model, and
an inhibition module, the inhibition module being suitable for inhibiting receipt, by the analysis module, of the prediction of at least one estimation module among the first estimation module, the second estimation module, and the third estimation module;
the coordination system is part of one of the estimation devices;
each estimation device is suitable for receiving data acquired from a detection device;
the data acquired by the detection device are images or audio signals;
the physical magnitude characterizes the environment of the detection device, the physical magnitude being in particular the temperature or the presence and/or identification of an object in this environment;
the physical magnitude is a magnitude relating to a means of transport including the detection device, in particular a magnitude giving the trajectory of the means of transport;
the estimation device includes a sending module suitable for sending the estimate of the physical magnitude to be estimated to a control module, the control module being suitable for controlling a physical device as a function of the estimate of the physical magnitude to be estimated, in particular for modifying the operation of the physical device;
the physical device is a means of transport, in particular an aircraft.

The description also relates to a device for estimating a physical magnitude, the estimation device including:
a first estimation module, the first estimation module including:
a first receiving unit suitable for receiving data acquired by a detection device, and
a first computing unit suitable for applying a first estimation model to the data received by the first receiving unit in order to obtain a first prediction of the physical magnitude to be estimated,
a second estimation module, the second estimation module including:
a second receiving unit suitable for receiving data acquired by a detection device, and
a second computing unit suitable for applying a second estimation model to the data received by the second receiving unit in order to obtain a second prediction of the physical magnitude to be estimated, the second estimation model being an update of the first estimation model, and
an analysis module, the analysis module being suitable for analyzing the consistency of values resulting from the first prediction and the second prediction and for deducing, from the consistency analysis, an estimate of the physical magnitude to be estimated for the estimation device.

The description also relates to a device for estimating a physical magnitude, the estimation device including:
a first estimation module, the first estimation module including:
a first receiving unit suitable for receiving data acquired by a detection device, and
a first computing unit suitable for applying a first estimation model to the data received by the first receiving unit in order to obtain a first prediction of the physical magnitude to be estimated,
a second estimation module, the second estimation module including:
a second receiving unit suitable for receiving data acquired by a detection device, and
a second computing unit suitable for applying a second estimation model to the data received by the second receiving unit in order to obtain a second prediction of the physical magnitude to be estimated, the second estimation model being a first update of the first estimation model,
a third estimation module, the third estimation module including:
a third receiving unit suitable for receiving data acquired by a detection device, and
a third computing unit suitable for applying a third estimation model to the data received by the third receiving unit in order to obtain a third prediction of the physical magnitude to be estimated, the third estimation model being a second update of the first estimation model,
an analysis module, the analysis module being suitable for receiving each prediction and for obtaining an estimate of the physical magnitude to be estimated for the estimation device from the received predictions, and
an inhibition module, the inhibition module being suitable for inhibiting receipt, by the analysis module, of the prediction of at least one estimation module among the first estimation module, the second estimation module, and the third estimation module.

The description also relates to an estimation system of a physical magnitude, the estimation system including:
several devices for estimating the physical magnitude, each estimation device including an analysis module, each analysis module being suitable for analyzing the consistency of values resulting from predictions obtained by applying at least two estimation models to data acquired by a detection device, one estimation model being an update of another estimation model, in order to obtain a value representative of the consistency between the predictions, and
a coordination system suitable for applying an aggregation function to the values representative of the consistency between the predictions in order to obtain an aggregated value and suitable for deducing an estimate of the physical magnitude to be estimated from the aggregated value.

The description also has as its subject matter a method for estimating a physical magnitude, the estimation method being computer-implemented and including:
receiving data acquired by a detection device,
applying a first estimation model to the received data in order to obtain a first prediction of the physical magnitude to be estimated,
applying a second estimation model to the received data in order to obtain a second prediction of the physical magnitude to be estimated, the second estimation model being an update of the first estimation model,
analyzing the consistency of values resulting from the first prediction and the second prediction, and
deducing, from the consistency analysis, an estimate of the physical magnitude to be estimated.

The description also relates to a method for estimating a physical magnitude including:
receiving data acquired by a detection device,
applying a first estimation model to the received data in order to obtain a first prediction of the physical magnitude to be estimated,
applying a second estimation model to the received data in order to obtain a second prediction of the physical magnitude to be estimated, the second estimation model being a first update of the first estimation model,
applying a third estimation model to the received data in order to obtain a third prediction of the physical magnitude to be estimated, the third estimation model being a second update of the first estimation model,
receiving each prediction, receipt of the prediction of at least one estimation module among the first estimation module, the second estimation module, and the third estimation module being inhibited by an inhibition module, and
obtaining an estimate of the physical magnitude to be estimated for the estimation device from the received predictions.

The description also relates to a method for estimating a physical magnitude, the estimation method being computer-implemented and including:
obtaining values representative of the consistency between the predictions of several physical magnitude estimation devices by analyzing the consistency of values resulting from predictions obtained by applying at least two estimation models to data acquired by a detection device, one estimation model being an update of another estimation model,
applying an aggregation function to the values representative of the consistency between the predictions in order to obtain an aggregated value, and
deducing an estimate of the physical magnitude to be estimated from the aggregated value.

In the present description, the expression “suitable for” means interchangeably “adapted for”, “adapted to”, or “configured for”.

### BRIEF DESCRIPTION OF THE DRAWINGS

The invention will appear more clearly upon reading the description that follows, given solely by way of non-limiting example, and made with reference to the drawings wherein:

FIG. 1 is a schematic representation of an example of a system for estimating a physical magnitude including a detection device and an estimation device;

FIG. 2 is a representation of the operation of the units of the estimation device shown in FIG. 1;

FIG. 3 is a flowchart of an example implementation of an estimation method by the estimation system shown in FIG. 1;

FIG. 4 is a schematic representation of another example of a system for estimating a physical magnitude including a detection device and an estimation device;

FIG. 5 is a representation of an example of operation of the units of the estimation device shown in FIG. 4;

FIG. 6 is a flowchart of an example implementation of an estimation method by the estimation system shown in FIG. 4;

FIG. 7 is a schematic representation of an example of a system for estimating a physical magnitude including a coordination system;

FIG. 8 is a flowchart of an example implementation of an estimation method by the estimation system shown in FIG. 7;

FIG. 9 is a schematic representation of another example of a system for estimating a physical magnitude including a coordination system; and

FIG. 10 is a schematic representation of yet another example of a system for estimating a physical magnitude including a coordination system.

### DETAILED DESCRIPTION OF THE INVENTION

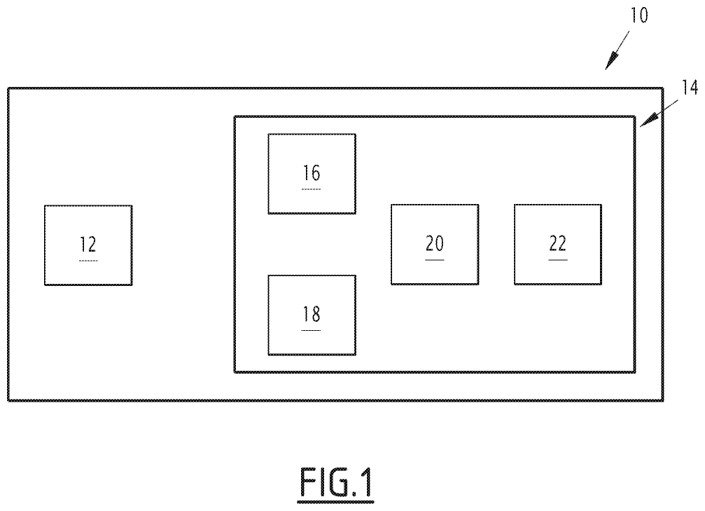

An estimation system 10 is illustrated in FIG. 1.

The estimation system 10 is suitable for estimating a physical magnitude.

The physical magnitude may be of any type, the estimation system 10 thus serving as a measurement system.

According to a particular example, the estimation system 10 may be seen as a system for observing the environment.

The estimation system 10 includes a detection device 12 and an estimation device 14.

The detection device 12 is suitable for acquiring data.

To this end, the detection device 12 includes one or more sensors suitable for collecting data.

The collected data are thus measurements.

According to the described example, the detection device 12 is a camera, the camera providing images.

The data acquired by the detection device 12 are thus images.

Alternatively or additionally, the detection device 12 may include any type of sensors, and in particular sensors suitable for collecting signals of the audio, video, time series, tabular data type, or any other type of signals.

The estimation device 14 is a device for estimating a physical magnitude.

The estimation device 14 is suitable for applying processing to data acquired by the detection device 12 in order to obtain an estimated value, which corresponds to the value of the sought physical magnitude.

These processing operations involve applying an estimation model to data acquired by the detection device 12.

The estimation model is a model resulting from artificial intelligence and, in particular, a model obtained by machine learning.

By way of non-limiting example, the estimation model is a neural network.

The estimation model is suitable for providing an estimated value of the physical magnitude over the predefined domain of use ODD.

The predefined domain of use is, by definition, the set of operating conditions wherein the estimation model is specifically designed to operate, including, but not limited to, environmental, geographical, and temporal restrictions.

In the present context, the estimation model is a model intended to evolve over time.

This evolution may have several causes.

For example, the performance of the estimation model is not sufficient, the estimation model must perform a different or additional task, or the evaluation criteria of the estimation model change (in a particular case due to regulatory changes).

Such an evolution of the model is generally obtained by retraining on a new data increment and associated activities of constrained incremental qualification (i.e., incompletely).

This corresponds to incremental learning implying that the estimation model will have multiple versions.

As will appear in the following, the estimation device 14 here makes it possible to use two successive versions of the estimation model, a first version before update and a second version after update, having been qualified under constraint.

To clearly illustrate this, a specific estimation model that is a classifier is considered.

The estimation device 14 includes a first estimation module 16, a second estimation module 18, an analysis module 20, and a warning module 22.

The first estimation module 16 is suitable for obtaining a first prediction and a first value representative of confidence in this prediction from data acquired by the detection device 12.

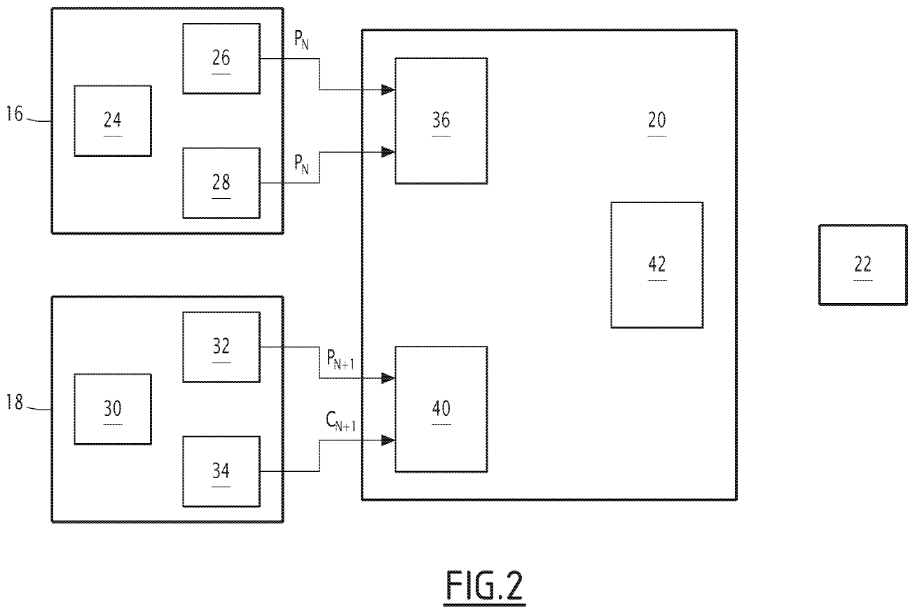

In FIG. 2, the first prediction is denoted P_{N} whereas the first value representative of confidence is denoted C_{N}.

The first estimation module 16 includes a first receiving unit 24, a first computing unit 26, and a first determination unit 28.

The first receiving unit 24 is suitable for receiving the data acquired by the detection device 12.

The first computing unit 26 is suitable for applying a first estimation model to the data received by the first receiving unit 24 in order to obtain the first prediction P_{N}.

The first estimation model is here assumed to be version N, N being an integer greater than or equal to 1.

As a result, the first estimation model is denoted ME_{N} and thus corresponds here to the estimation model before the update (here the Nth).

To simplify the notations, the first estimation model will be denoted simply estimation model ME_{N}.

An estimation model is considered that would be able to classify the input data according to three output classes: a first class, a second class, and an anomaly class.

The anomaly class corresponds to abnormal data.

In such a case, this implies that the estimation model taking an abnormal input datum must, in normal operation, interpret such a datum as an anomaly. Typically, the estimation model will output an error code or a classification of the abnormal datum as, for example, an unknown datum.

More precisely, it is assumed that the estimation model ME_{N} is a recognition model suitable for identifying, in the observed environment, two elements, hereinafter named element A (first class) and element B (second class). Any other element is not recognized by the estimation model ME_{N} (anomaly class).

The first prediction P_{N} is therefore element A, element B, or anomaly.

The first determination unit 28 is suitable for determining a first value representative of confidence in the prediction of the first computing unit 26.

For example, the first determination unit 28 applies a function suitable for providing confidence given the estimation model ME_{N} and the first prediction P_{N}.

According to another example, the first determination unit 28 uses the estimation model ME_{N}. In such a case, the first computing unit 26 and the first determination unit 28 may be the same, the estimation model ME_{N} then being suitable for providing, at the output, the first prediction P_{N} and the first value representative of confidence C_{N} in the prediction of the first computing unit 26.

The first value representative of confidence in the prediction of the first computing unit 26 is notably expressed in the form of a probability, without this example being limiting.

The second estimation module 18 is suitable for obtaining a second prediction and a second value representative of confidence in this prediction from data acquired by the detection device 12.

In FIG. 2, the second prediction is denoted P_{N+1} whereas the second value representative of confidence is denoted C_{N+1}.

The second estimation module 18 includes a second receiving unit 30, a second computing unit 32, and a second determination unit 34.

The second receiving unit 30 has the same role as the first receiving unit 24.

In one embodiment, the first receiving unit 24 and the second receiving unit 30 are the same.

The second computing unit 32 is suitable for applying a second estimation model to the data received by the second receiving unit 30 in order to obtain the second prediction P_{N+1}.

The second estimation model corresponds to the update of the first estimation model ME_{N}, here by implementing incremental learning.

Stated otherwise, the second estimation model corresponds to version (or increment) N+1 of the estimation model.

As a result, the second estimation model is denoted ME_{N+1} and will therefore be referred to below as the estimation model ME_{N+1} to simplify the notations.

In the described example, it is assumed that the update aims to obtain an estimation model ME_{N+1} suitable for identifying, in the observed environment, two elements, hereinafter named element C (first class) and element B (second class). Any other element is not recognized by the estimation model ME_{N+1} (anomaly class).

Element C is different from element A that the estimation model ME_{N} is suitable for recognizing.

The second determination unit 34 is suitable for determining a second value representative of confidence C_{N+1} in the prediction of the second computing unit 32.

Remarks similar to those regarding the first determination unit 28 are also valid here and are not repeated for conciseness.

The analysis module 20 is suitable for receiving the outputs of estimation modules 16 and 18 and for selecting the best estimate of the physical magnitude to be estimated.

According to the described example, the analysis module 20 is suitable for analyzing the outputs of estimation modules 16 and 18 in order to output the best prediction.

More specifically, in the illustrated example, to obtain the best prediction, the analysis module 20 takes as input the different predictions P_{N} and P_{N+1} and the confidence scores C_{N} and C_{N+1} and outputs a predicted value for the warning module 22. This predicted value is specified below.

As shown in FIG. 2, the analysis module 20 includes a first consolidation unit 36, a second consolidation unit 40, and a verification unit 42.

The first consolidation unit 36 is suitable for consolidating the first prediction P_{N} of the first estimation module 16.

For this purpose, the first consolidation unit 36 is suitable for obtaining such a first consolidated prediction PC_{N} as a function of a confidence criterion depending on the first confidence value C_{N}.

According to the described example, the performance criterion is a comparison with a threshold.

The first consolidation unit 36 compares the first confidence value C_{N} to a predefined threshold S_{N}.

The predefined threshold S_{N} is, for example, provided with the estimation model ME_{N}, this value being determined during training of the estimation model ME_{N} as a function of its performance on a test dataset.

When the first confidence value C_{N} is greater than or equal to the threshold, the first consolidation unit 36 outputs a first consolidated prediction PC_{N} equal to the first prediction P_{N} of the first estimation module 16.

Conversely, when the first confidence value C_{N} is strictly less than the threshold, the first consolidated prediction PC_{N} is the anomaly class (regardless of the value of the first prediction P_{N}).

The second consolidation unit 40 operates similarly to the first consolidation unit 36 for the second prediction P_{N+1}.

Thus, when the second confidence value C_{N+1} is greater than or equal to a predefined threshold S_{N+1}, the second consolidation unit 40 outputs a second consolidated prediction PC_{N+1} equal to the second prediction P_{N+1} of the second estimation module 18.

Conversely, when the second confidence value C_{N+1} is strictly less than the predefined threshold S_{N+1}, the second consolidated prediction PC_{N+1} is the anomaly class (regardless of the value of the second prediction P_{N+1}).

The verification unit 42 is a unit for verifying consistency between the consolidated predictions PC_{N} and PC_{N+1} of the two consolidation units 36 and 40.

The verification unit 42 is suitable for comparing the values from the two consolidation units 36 and 40 and for deducing a verified prediction PV as a function of the result of the comparison.

According to one embodiment, the verification unit 42 uses a truth table to perform the comparison and deduction actions.

The truth table is a function taking as input the value of the first consolidated prediction PC_{N} and the value of the second consolidated prediction PC_{N+1} and outputting the verified prediction PV.

TABLE 1 below provides the truth table used by the verification unit 42 for the described example with the two estimation models ME_{N} and ME_{N+1}.

| First | Second | | |
|---|---|---|---|
| consolidated | consolidated | Result of | |
| prediction | prediction | the | Verified |
| PC_{N} | PC_{N+1} | comparison | prediction PV |
| Element A | Element C | Disagreement | Output of |
| | | | model |
| | | | ME_{N} (element |
| | | | A) |
| Element A | Element B | Disagreement | Output of |
| | | | model |
| | | | ME_{N} (element |
| | | | A) |
| Element A | Unrecognized | Agreement | Output of |
| | (neither C nor | | model |
| | B) | | ME_{N+1} |
| | | | (neither C nor |
| | | | B) |
| Element B | Element C | Disagreement | Output of |
| | | | model |
| | | | ME_{N} (element |
| | | | B) |
| Element B | Element B | Agreement | Output of |
| | | | model ME_{N+1} |
| | | | (element B) |
| Element B | Unrecognized | Disagreement | Output of |
| | (neither C nor | | model |
| | B) | | ME_{N} (element |
| | | | B) |
| Unrecognized | Element C | Agreement | Output of |
| (neither A nor | | | model ME_{N+1} |
| B) | | | (element C) |
| Unrecognized | Element B | Disagreement | Output of |
| (neither A nor | | | model |
| B) | | | ME_{N} |
| | | | (neither A nor |
| | | | B) |
| Unrecognized | Unrecognized | Agreement | Output of |
| (neither A nor | (neither C nor | | model ME_{N+1} |
| B) | B) | | (neither C nor |
| | | | B) |

From analysis of the preceding table, it follows that, when the first consolidated prediction PC_{N} and the second consolidated prediction PC_{N+1} are inconsistent, the analysis module 20 is suitable for deducing that the value of the estimate of the physical magnitude is the first consolidated prediction PC_{N}.

Conversely, when the first consolidated prediction PC_{N} and the second consolidated prediction PC_{N+1} are consistent, the analysis module 20 is suitable for deducing that the value of the estimate of the physical magnitude is the second consolidated prediction PC_{N+1}.

In this embodiment, the lack of consistency between the two estimation models ME_{N} and ME_{N+1} is thus a sign that the estimation model ME_{N+1} is not sufficiently reliable.

Thus, the analysis module 20 analyzes the consistency of values resulting from the first prediction P_{N} and the second prediction P_{N+1} and deduces therefrom an estimate of the physical magnitude to be estimated.

The warning module 22 is suitable for issuing an alert in the event of temporal persistence of a disagreement at the output of 42 (disagreement between the predictions of the two estimation models ME_{N} and ME_{N+1}).

To evaluate the existence of temporal persistence, the warning module 22 analyzes the number of disagreements over a set of comparisons performed by the verification unit 42.

According to one example, the warning module 22 will accumulate the comparison results and apply a persistence criterion to at least part of the accumulated results to determine whether it should issue a warning or not.

According to a simple example, when this number of results exceeds a threshold K, the warning module 22 implements, for example, an aggregation technique as described below. K is here a natural integer strictly greater than 1.

The threshold K is configurable, so that the warning model performs an aggregation over a configurable sliding window.

More precisely, for comparisons k to k-K (k being an integer greater than or equal to K), the number of disagreements is compared to a threshold, exceeding the threshold leading to emission of an alarm by the warning module 22.

Alternatively, it is possible to consider the percentage of disagreements instead of the number of disagreements.

It is also possible to consider verifying only consolidated results.

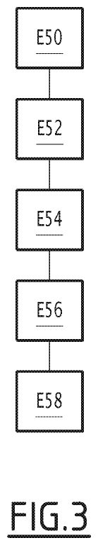

In operation, the estimation system 10 thus implements a method for estimating a physical magnitude, for example, like the one described with reference to FIG. 3.

The method includes a receiving operation E50, a first application operation E52, a second application operation E54, an analysis operation E56, and a deduction operation E58.

During the receiving operation E50, the data acquired by a detection device 12 are received by the first estimation module 16 and the second estimation module 18.

During the first application operation E52, the first computing unit 26 applies the estimation model ME_{N} to the received data to obtain the first prediction P_{N} of the physical magnitude to be estimated.

During the second application operation E54, the second computing unit 32 applies the estimation model ME_{N+1} to the received data to obtain the second prediction P_{N+1} of the physical magnitude to be estimated.

The two application operations E52 and E54 may be implemented in parallel, potentially with synchronization constraints depending on the applications.

During the analysis operation E56, the analysis module 20 analyzes the consistency of values resulting from the first prediction P_{N} and the second prediction P_{N+1}.

In this case, the values resulting from the first prediction P_{N} and the second prediction P_{N+1} are the consolidated values PC_{N} and PC_{N+1}.

During the deduction operation E58, the analysis module 20 deduces, from the consistency analysis, an estimate of the physical magnitude to be estimated.

To do this, the analysis module 20 applies, for example, the preceding truth table.

The estimation device 14 is thus suitable for monitoring the update of an estimation model ME by comparing predictions between the estimation model ME_{N} (before the update) and the estimation model ME_{N+1} (after the update).

More precisely, the estimation device 14 monitors, in inference, the new estimation model ME_{N+1} using the predictions of the estimation model ME_{N}. This monitoring takes the form of a comparison of their inputs and/or their internal states and/or their outputs in real time, and a deduction of a consolidated prediction on the datum seen in inference.

This comparison is performed here by the verification unit 42 on the basis of a truth table.

The truth table is to be understood here in the sense of a comparison and consolidation logic.

In this sense, the estimation device 14 corresponds to a dual-path processing architecture making it possible both to implement two estimation models (here the models ME_{N} and ME_{N+1}) and to control this implementation.

This also makes it possible to drastically minimize the development costs of a monitoring solution because adding the increment itself will facilitate this process via the use of at least consistency analysis possibly supplemented by a temporal persistence logic (performed by the warning module 22).

The estimation device 14 therefore makes it possible to effectively detect novelties and drifts, which makes it possible to increase confidence in the estimation model. The estimation device 14 thus provides a solution to the problem of qualification and user confidence in its estimation system 10 in the context of updates to the used estimation model.

The estimation device 14 does not involve specifically developing a dedicated monitoring tool, which may be costly since it uses only the two estimation models to confront them and verify in particular that the new estimation model ME_{N+1} properly meets the new requirements as well as the old requirements (those of estimation model ME_{N}) still valid while no longer meeting the abandoned old requirements. The estimation device 14 may also verify in some cases that the predefined domain of use of the estimation model ME_{N+1} is properly preserved when relevant.

In the example just described, the first estimation module 16, the second estimation module 18, the analysis module 20, and the warning module 22 are each implemented in the form of software, or a software and/or hardware block (e.g., FPGA), executable by the processor.

The memory of the estimation device 14 is then able to store a first estimation software program, a second estimation software program, an estimation software program, and a warning software program. The processor is then able to execute each of the software programs among the first estimation software program, the second estimation software program, the estimation software program, and the warning software program.

All these units may be developed using software technologies, such as assembly, C++, Java, C, RUST, Go, or Python. The choice of programming language will be defined by the level of criticality of the use of the estimation system 10 and/or the desired performance.

The platform on which these units will run depends on the use case. It may be a simple traditional server or a workstation with local graphics processing units (GPU) or edge computing, or a distributed platform.

In a non-illustrated variant, the first estimation module 16, the second estimation module 18, the analysis module 20, and the warning module 22 are each implemented in the form of a programmable logic component, such as an FPGA (Field Programmable Gate Array), or alternatively an integrated circuit such as an ASIC (Application Specific Integrated Circuit).

When the estimation device 14 is implemented in the form of one or more software programs, i.e., in the form of a computer program, also called a computer program product, it is also suitable for being recorded on a non-illustrated computer-readable medium. The computer-readable medium is, for example, a medium suitable for storing electronic instructions and for being coupled to a bus of a computer system. By way of example, the readable medium is an optical disk, a magneto-optical disk, a ROM memory, a RAM memory, any type of non-volatile memory (for example, FLASH or NVRAM), or a magnetic card. A computer program including software instructions is then stored on the readable medium.

These remarks relating to the physical implementation of the first estimation module 16, the second estimation module 18, the analysis module 20, and the warning module 22 are also valid for the units contained in these modules.

Other embodiments of the estimation device 14 are possible.

In particular, it is possible to consider simpler implementations of the estimation device 14. It may, for example, use a simple comparison of the predictions P_{N} and P_{N+1}.

It is also possible to directly use the values representative of confidence C_{N} and C_{N+1} in the verification unit 42, which avoids using the two consolidation units 36 and 40.

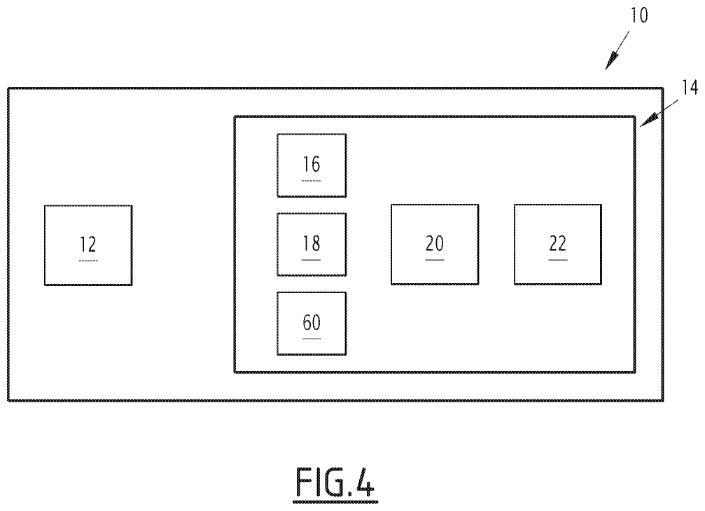

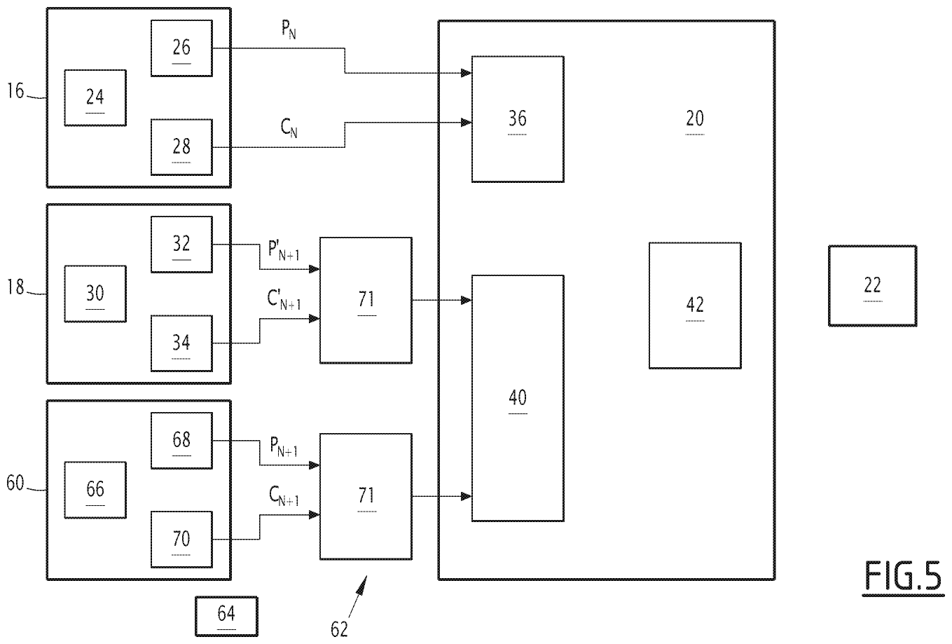

An estimation system 10 according to another embodiment is also illustrated in FIGS. 4 and 5.

The estimation system 10 includes the same elements as the estimation system 10 shown in FIGS. 1 and 2.

In particular, the estimation device 14 according to FIG. 3 includes the first estimation module 16, the second estimation module 18, the analysis module 20, and the warning module 22.

Compared to the previous example, the second computing unit 32 applies a second estimation model that is an intermediate version between the Nth version of the estimation model ME_{N} applied by the first computing unit 26 and the (N+1)th version of the estimation model ME_{N+1}.

To avoid confusion, the second estimation model will be denoted ME′_{N+1}. The predictions and confidence values will also be denoted with a “′” as P′_{N+1} and C′_{N+1}.

The estimation system 10 also includes a third estimation module 60, an inhibition module 62, and a control module 64.

The third estimation module 60 includes a third receiving unit 66, a third computing unit 68, and a third determination unit 70.

The third receiving unit 66 has the same role as the first receiving unit 24 or the second receiving unit 30.

In one embodiment, the first receiving unit 24, the second receiving unit 30, and the third receiving unit 66 are the same.

The third computing unit 68 is suitable for applying a third estimation model to the data received by the third receiving unit 66 in order to obtain a third prediction P_{N+1}.

The third estimation model corresponds either to a second update of the first estimation model ME_{N} or to an update of the estimation model ME′_{N+1}, here by implementing incremental learning.

The second update is different from the first update.

Stated otherwise, in the described example, the third estimation model corresponds to version (or increment) N+1 of the estimation model.

As a result, the third estimation model is denoted ME_{N+1} and will therefore be referred to below as the estimation model ME_{N+1} to simplify the notations.

The third determination unit 70 is suitable for determining a third value representative of confidence C_{N+1} in the prediction of the third computing unit 68.

In one embodiment, the second determination unit 34 and the third determination unit 70 are the same.

The inhibition module 62 is suitable for inhibiting receipt by the analysis module 20 of the prediction of at least one estimation module among the first estimation module 16, the second estimation module 18, and the third estimation module 60.

Here, the term “inhibiting” means “preventing” or “interrupting” depending on the chosen operation for the inhibition module 62. An example for each of these two definitions will be given later in the description.

According to the described example, the inhibition module 62 is suitable for inhibiting only receipt of the prediction P′_{N+1} of the second estimation module 18 or the prediction P_{N+1} of the third estimation module 60.

This implies that the estimation device 14 always has the first prediction P_{N}, this prediction serving in this context as a reference prediction.

In addition, the inhibition module 62 has two states.

In such a case with only two states, the inhibition module 62 may be considered as a switching module insofar as the inhibition module 62 makes it possible to switch between the prediction of the second estimation module 18 and the prediction of the third estimation module 60.

The first state is a state of the inhibition module 62 wherein only receipt of the prediction of the second estimation module 18 is inhibited. Stated otherwise, the first state is an inhibition state of the second estimation module 18.

The second state is a state of the inhibition module 62 wherein only receipt of the prediction of the third estimation module 60 is inhibited. The second state is thus an inhibition state of the third estimation module 60.

An example of a physical implementation of the inhibition module 62 is given for illustration in FIG. 5.

In this example, the inhibition module 62 includes an inhibition unit 71 for each estimation module 18 and 60 whose prediction receipt by the analysis module 20 the inhibition module 62 is suitable to inhibit.

For example, the inhibition unit 71 is a switch having an open position wherein receipt of the prediction by the analysis module 20 is inhibited and a closed position wherein receipt of the prediction by the analysis module 20 is not inhibited.

The control module 64 is suitable for controlling the state of the inhibition module 62, i.e., for sending it a command to switch to one of the previous states.

According to one particular example, the control module 64 is suitable for causing implementation of an operation for loading the third estimation model ME_{N+1} onto the third computing unit 68.

For this purpose, the control unit 64 is suitable for interacting with an external device to be informed of availability of the estimation model ME_{N+1} and to obtain this model.

Such obtaining is generally implemented by on-the-fly downloading.

This implies that the estimation system 10 is also provided with a remote downloading unit (transmitter/receiver) for the estimation model weights that is reliable, high-performance and secure. Access to a memory storing the weights for reading and writing is also used.

In such a case, the control module 64 applies a control law to the inhibition module 62 having the effect that the inhibition module 62 is in the first state when the loading operation has not been implemented and in the second state when the loading operation has taken place.

This allows the analysis module 20 to have the most up-to-date version of the estimation model, namely first the intermediate estimation model and then the estimation model ME_{N+1} when it is available.

The analysis module 20 then operates as before, the received predictions and confidence values being those originating from the first estimation module 16 as well as either those of the second estimation module 18 or those of the third estimation module 60.

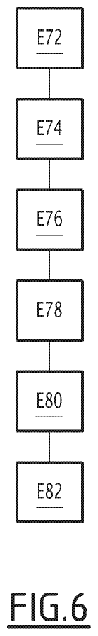

An example operation of the estimation system 10 shown in FIGS. 4 and 5 is now described with reference to FIG. 6, which illustrates an example implementation of a method for estimating a physical magnitude by this estimation system 10.

The estimation method includes a first receiving operation E72, a first application operation E74, a second application operation E76, a third application operation E78, a second receiving operation E80, and an obtaining operation E82.

During the first receiving operation E72, the data acquired by a detection device 12 are received by the first estimation module 16, the second estimation module 18, and the third estimation module 60.

During the first application operation E74, the first computing unit 26 applies the estimation model ME_{N} to the received data to obtain the first prediction P_{N} of the physical magnitude to be estimated.

During the second application operation E76, the second computing unit 32 applies the estimation model ME′_{N+1} to the received data to obtain the second prediction P′_{N+1} of the physical magnitude to be estimated.

During the third application operation E78, the third computing unit 60 applies the estimation model ME_{N+1} to the received data to obtain the third prediction P_{N+1} of the physical magnitude to be estimated.

The application operations E74, E76, and E78 may be implemented simultaneously.

During the second receiving operation E80, the analysis module 20 receives exactly two predictions, systematically including receipt of the prediction of the first estimation module 16, and receipt of a prediction from among the second estimation module 18 or the third estimation module 60, the other being inhibited by an inhibition module 62.

During the obtaining operation E82, the analysis module 20 obtains an estimate of the physical magnitude to be estimated for the estimation device 14 from the received predictions.

Such an obtaining operation E82 is, for example, implemented by a consistency analysis as described above.

Such general operation may be used for several different use cases.

A first example was given for the case of downloading the estimation model ME_{N+1} in use. The intermediate estimation model ME′_{N+1} is then used for lack of the estimation model ME_{N+1}, notably because its training takes too long.

This makes it possible to ensure continuity in the use of the estimation model insofar as updated estimation models are made available continuously and the transition from one version of the estimation model to another version is easy since it does not involve interrupting use (stopping and restarting avoided).

According to a second example, the intermediate estimation model ME′_{N+1} has a major safety problem; it may thus be envisaged to update the intermediate estimation model ME′_{N+1} to remedy the identified major problem.

In such a case, the intermediate update would relate only to the weight values while keeping the rest of the neural network architecture (for example, same number of neurons, layers, identical operators). This thus consists in making a small adjustment (more often designated by the corresponding term “fine tuning”).

This makes it possible to only have to load the estimation model weights. This technique may also be used for loading version N+1 of the estimation model ME_{N+1}.

Indeed, such a technique is compatible with embedded constraints where resources are limited.

Through these non-limiting examples, it appears that the estimation system 10 makes it possible to perform development and qualification on incremental learning of an estimation model with relaxed constraints.

To this end, the estimation system 10 proposes a three-path processing architecture making it possible to implement and monitor a version N of the estimation model, an intermediate version of the estimation model, and a version N+1 of the estimation model (for example, obtained by a patch loaded on the fly).

The estimation system 10 thus takes advantage of the time in use to continue qualification of version N+1 (performed under constraints) and thus to have a version N+1 that is as robust and as mature and stable as possible.

Other embodiments are also possible.

In particular, it is possible to share components of the second estimation module 18 and the third estimation module 60.

For example, the determination unit suitable for determining the values representative of confidence in the prediction may be shared, the inhibition module 62 then being placed upstream of this shared determination unit.

It may also be envisaged that an inhibition module 62 be positioned so as to prevent sending data to the computing unit that the inhibition module 62 wishes to inhibit.

Each of the observation systems 10 just described may be used in a collaborative context.

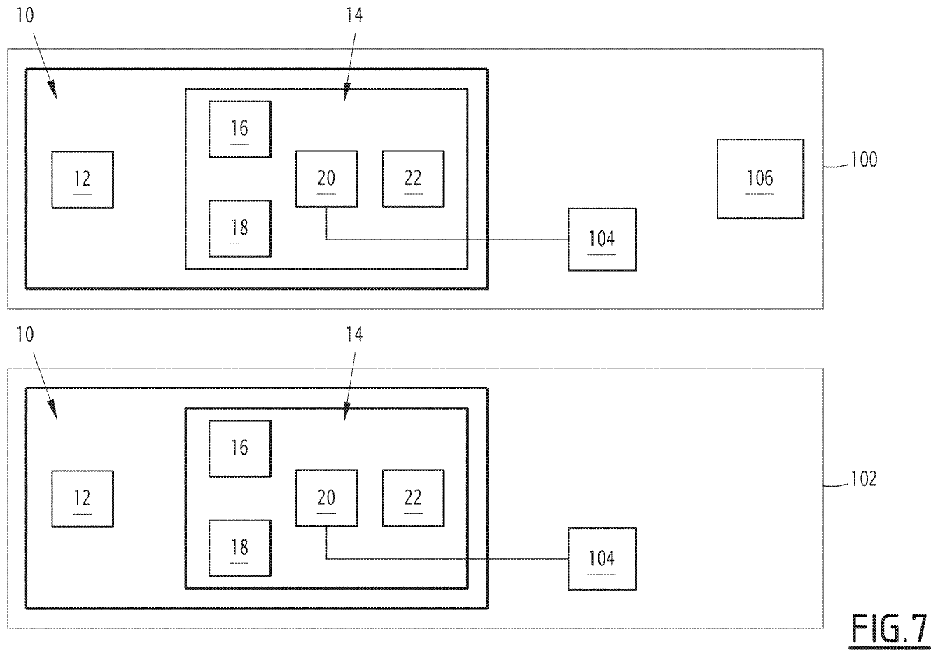

Such a case is schematized in FIG. 7 wherein two sets 100 and 102 are shown.

A set is here a carrier, typically a drone, a fighter aircraft, a transporter, a tanker, or a surveillance aircraft.

Each set 100 or 102 includes an estimation system 10 and a communication system 104 enabling communication with the other set 100 or 102.

The observation systems 10 are either (i) homogeneous, i.e., of the same type, either according to the first example shown in FIG. 2 or according to the second example shown in FIG. 3, or (ii) heterogeneous combining the two examples.

Each communication system 104 is suitable for exchanging information between each set 100 or 102.

In the described example, the information are values representative of the consistency between the predictions of the estimation models used by each estimation system 10.

More precisely, in the case of FIG. 7, the information are the results of the comparisons of the verification units 42 of each estimation system 10.

The first set 100 also includes a coordination system 106. The coordination system 106 is, for example, a computer.

The coordination system 106 is suitable for obtaining, via interactions with the communication systems 104, the comparison results of the verification units 42 of each estimation system 10.

The coordination system 106 then applies an aggregation function to the values representative of the consistency between the predictions in order to obtain an aggregated value.

In general, aggregation functions are mathematical operations that combine values to obtain a final value.

According to a particular example, the aggregation function is a majority vote.

This vote may be weighted, for example, by taking into account the fact that one set may be better positioned to observe the environment and therefore that, a priori, its prediction is more reliable.

Alternatively, the aggregation function is a fuzzy logic function.

According to another embodiment, the aggregation function is a statistical function, notably by computing performance statistics as a function of the task performed by the estimation model.

The coordination system 106 is suitable for deducing an estimate of the physical magnitude to be estimated from the aggregated value.

By way of example for the described case, the coordination system 106 implements the deduction according to the following truth table.

| | | Coordination | |
|---|---|---|---|
| Result for | Result for | aggregation | Deduced |
| the set 100 | the set 102 | system 106 | prediction |
| Disagreement | Disagreement | Disagreement | Output of |
| | | | model ME_{N} |
| Disagreement | Agreement | Disagreement | Output of |
| | | | model ME_{N} |
| Agreement | Disagreement | Disagreement | Output of |
| | | | model ME_{N} |
| Agreement | Agreement | Agreement | Output of |
| | | | model ME_{N+1} or |
| | | | ME′_{N+1} |

The coordination system 106 is then suitable for sharing with each estimation system 10 a consolidated recommendation based on an overall consistency status indicating the estimate of the physical magnitude to be used by each estimation device 14.

For this purpose, the coordination system 106 includes a (non-illustrated) communication unit suitable for communicating with each of the communication systems 104.

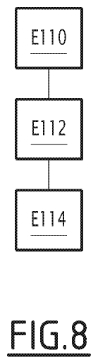

The associated operation corresponds to the flowchart shown in FIG. 8.

The estimation method includes an obtaining operation E110, an application operation E112, and a deduction operation E114.

During the obtaining operation 110, each analysis module 20 analyzes the consistency of values resulting from predictions obtained by applying the estimation models to data acquired by a detection device 12, one estimation model being an update of another estimation model, to obtain a value representative of the consistency between the predictions.

During the application operation E112, the coordination system 106 applies an aggregation function to the values representative of the consistency between the predictions in order to obtain an aggregated value.

During the deduction operation E114, the coordination system 106 deduces an estimate of the physical magnitude to be estimated from the aggregated value.

The estimation method just described makes it possible to add a collective-type consolidation logic.

This makes it possible to increase prediction reliability.

The estimation system 10 therefore makes it possible to benefit from the simultaneous presence of several sets 100 and 102 to consolidate the prediction, which makes it possible to increase the reliability of the simultaneous use of the two estimation models ME_{N} and ME_{N+1} or ME_{N} and ME′_{N+1}.

Other embodiments are possible.

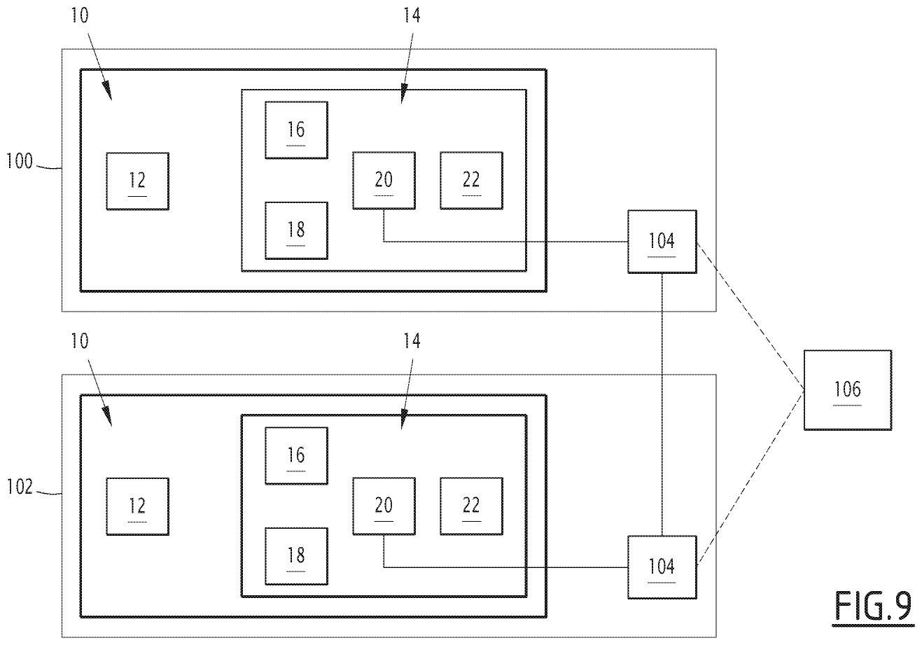

In particular, with reference to FIG. 9, the coordination system 106 may be a central system located remotely from each of the sets 100 and 102.

The coordination system 106 remains connected to each of the communication systems 104.

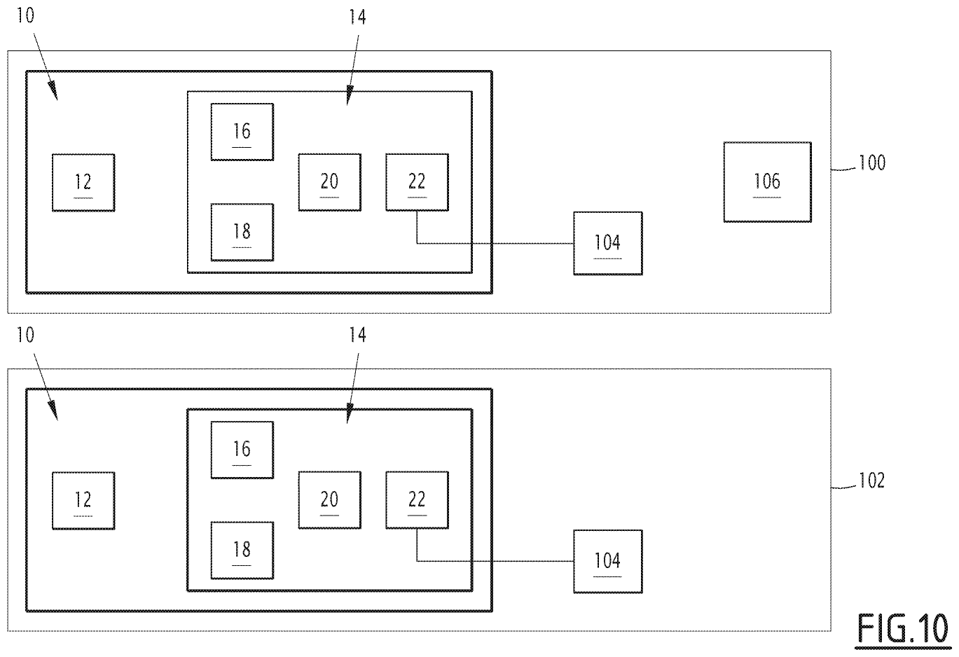

Alternatively or additionally, as schematized in FIG. 10, the values representative of the consistency between the predictions of the estimation models are the values obtained by the warning modules 22.

Typically, the coordination system 106 will use the percentage of disagreement of each warning module 22 to deduce the common prediction for each estimation system 10.

More broadly, each warning module 22 is suitable for obtaining a value representative of the temporal evolution of the results of the consistency analysis, and the values representative of the consistency between the predictions are these values representative of the temporal evolution.

By way of an advantageous example, it may be envisaged to use in cascade an individual consistency status (acronym SIC), an individual collaborative consistency status (abbreviation SICC), and a persistent collaborative consistency status (SPCC). This makes it possible to combine two consolidations: a consolidation between collaborative units (SICC) and a temporal consolidation (SPCC).

This may be illustrated for a two-unit case by the following table:

| Time | SIC unit 1 | SIC unit 2 | SICC | SPCC |
|---|---|---|---|---|
| 0 | agreement | disagreement | disagreement | |
| 1 | disagreement | agreement | disagreement | disagreement |
| . . . | agreement | agreement | agreement | disagreement |
| K − 1 | agreement | agreement | agreement | agreement |
| K | agreement | disagreement | disagreement | disagreement |

In this example, unit 1 is the master unit whereas unit 2 is the follower unit.

The extension to more than one follower unit is immediate since it suffices to add as many columns as there are follower units.

1. A device for estimating a physical magnitude, comprising:
a first estimation module, the first estimation module comprising:
a first receiving unit receiving data acquired by a detection device; and
a first computing unit applying a first estimation model to the data received by said first receiving unit in order to obtain a first prediction of the physical magnitude to be estimated;
a second estimation module, comprising:
a second receiving unit receiving data acquired by a detection device; and
a second computing unit suitable for applying a second estimation model to the data received by said second receiving unit in order to obtain a second prediction of the physical magnitude to be estimated, the second estimation model being an update of the first estimation model; and
an analysis module, analyzing consistency of values resulting from the first prediction and the second prediction and deducing, from the consistency analysis, an estimate of the physical magnitude to be estimated for the device.

2. The device according to claim 1, wherein, when the value resulting from the first prediction and the value resulting from the second prediction are inconsistent, said analysis module deduces that the value of the estimate of the physical magnitude is the value resulting from the first prediction.

3. The device according to claim 1, wherein, when the value resulting from the first prediction and the value resulting from the second prediction are consistent, said analysis module deduces that the value of the estimate of the physical magnitude is the value resulting from the second prediction.

4. The device according to claim 1, wherein said first estimation module comprises a first determination unit of a first value representative of confidence in the prediction of said first computing unit, and said second estimation module comprises a second determination unit of a second value representative of confidence in the prediction of said second computing unit, the values resulting from the first prediction and the second prediction whose consistency is checked by said analysis module being obtained from the first prediction, the second prediction, the first value representative of confidence in the prediction of said first computing unit, and the second value representative of confidence in the prediction of said second computing unit.

5. The device according to claim 4, wherein said analysis module further comprises:
a first consolidation unit obtaining a first consolidated prediction from the first prediction as a function of a first confidence criterion applied to the first value representative of confidence in the prediction of said first computing unit; and
a second consolidation unit suitable for obtaining a second consolidated prediction from the second prediction as a function of a second confidence criterion applied to the second value representative of confidence in the prediction of said second computing unit, the values resulting from the first prediction and the second prediction whose consistency is checked by said analysis module being respectively the first consolidated prediction and the second consolidated prediction.

6. The device according to claim 5, wherein the first confidence criterion is a comparison of the first value representative of confidence in the prediction of said first computing unit to a first predefined threshold, and the second confidence criterion is a comparison of the second value representative of confidence in the prediction of said second computing unit to a second predefined threshold.

7. The device according to claim 1, further comprising a warning module issuing an alert in the presence of multiple inconsistencies between values resulting from the first prediction and the second prediction whose consistency is checked by said analysis module.

8. The device according to claim 7, wherein said warning module accumulates results of the consistency analyses and issues the alert when the number of inconsistencies, for a number of successive consistency analysis results produced by said analysis module, is greater than or equal to a threshold.

9. A system for estimating a physical magnitude, comprising:
a detection device, the detection device being suitable for acquiring data; and
a device for a physical magnitude according to claim 1.

10. A method for estimating a physical magnitude, the method being computer-implemented and comprising:
receiving data acquired by a detection device;
applying a first estimation model to the received data in order to obtain a first prediction of the physical magnitude to be estimated;
applying a second estimation model to the received data in order to obtain a second prediction of the physical magnitude to be estimated, the second estimation model being an update of the first estimation model;
analyzing consistency of values resulting from the first prediction and the second prediction; and
deducing, from the consistency analysis, an estimate of the physical magnitude to be estimated.
